(19) United States
(12) Patent Application Publication
(10) Pub. No.: US 2004/0051687 A1
(43) Pub. Date: Mar. 18, 2004

(54) Carry-on device having cholesteric liquid crystal display

(76) Inventor: Yuan-Sung Weng, Taipei (TW)

Correspondence Address: BACON & THOMAS, PLLC, 625 SLATERS LANE, FOURTH FLOOR, ALEXANDRIA, VA, 22314

(21) Appl. No.: 10/244,744

(22) Filed: Sep. 17, 2002

(51) Int. Cl. G09G 3/36

(52) U.S. Cl. 345/87

(57) ABSTRACT

The invention provides a carry-on device having cholesteric liquid crystal display, including: a power supply unit for outputting a working voltage; a storage unit for storing a plurality of image data; a cholesteric liquid crystal display with function of displaying; a display control unit for control the display action of the cholesteric liquid crystal display; and a power control switch connected between the power supply unit and the cholesteric liquid crystal display, when said control switch is turned off, said cholesteric liquid crystal display may display the image of image data which is displayed before said control switch was turned off without power supplied from said power supply unit to said cholesteric liquid crystal display, which means a power saving effect capable of maintaining a long time displaying action.

### FIELD OF THE INVENTION

The present invention relates to a carry-on device, especially to a carry-on device having cholesteric liquid crystal display capable of displaying the image of image data which was just displayed before a power control switch was turned off when no power is supplied thereto, while consumes less power to maintain a long time displaying.

### BACKGROUND ART

In current market, in order to fulfil the need of modern customer on convenient use at any time and place, the manufacturer tends to miniaturize the electronic products for easy carry and practical use. For products such as personal digital assistant (PDA), digital camera, and mobile phone to achieve a portable convenience, such products are made to be light, thin, short, and small, as well as power saving that allows a long time use without frequently replacing or recharging of battery. An ordinary carry-on device has adapted a monochromatic gray-scaled Twisted-Nematic liquid crystal display (TN-LCD) or a thin-film transistor liquid crystal display (TFT-LCD) as its display. Although having a feature of small volume, said display also needs to be equipped with a refresh circuit to perform a continuous scan on the image for any variation of the image and supplied with power to perform continuous image display. Since such display consumes more power, the carry-on device of present time does not adapt such display for continuous long time display of a fixed image so as to prevent from consuming too much power that inhibit long time use of the carry-on device. Consequently, such carry-on device can not provide functions of variety, colorful and interesting by means of image displaying for the reason of power saving.

### SUMMARY OF THE INVENTION

Therefore, an object of present invention is to provide a carry-on device having cholesteric liquid crystal display, which is capable of saving power in order to maintain a long time displaying.

The present invention provides a carry-on device having cholesteric liquid crystal display comprising a power supply unit, a storage unit, a cholesteric liquid crystal display, a display control unit and a power control switch. The power supply unit is a voltage source capable of outputting a working voltage. The storage unit can be used to store a plurality of image data. The cholesteric liquid crystal display has two glass substrates and a cholesteric liquid crystal layer filled between the glass substrates. Said display control unit is electrically connected to the power supply unit, the storage unit and the cholesteric liquid crystal display, and is used to control the displaying of the cholesteric liquid crystal display according to different image data stored in the storage unit to provide continuous displaying. The power control switch is connected between the power supply unit and the cholesteric liquid crystal display with an on- or off-state. With the power control switch in on-state, the cholesteric liquid crystal display receives a working voltage from the power supply unit, the display control unit may perform control of displaying on the cholesteric liquid crystal display to display the corresponding image of different image data. With the power control switch in off-state, the power supply unit can't supply the working voltage to the cholesteric liquid crystal display, the display control unit can't perform control on the cholesteric liquid crystal display, and the cholesteric liquid crystal display would then display the image of image data before the power control switch was put into the off-state. With this, making use of the fact that the cholesteric liquid crystal display can display the image of image data which was just displayed before the power control switch was put into off-state when no power is supplied to the cholesteric liquid crystal display, it is possible to provide the function of power saving. It is then possible to perform a long time continuous display of a fixed image.

### BRIEF DESCRIPTION OF DRAWINGS

Other features and advantages of present invention will become more apparent from the detailed description in conjunction with the following drawings:

FIG. 1 is a block diagram showing an operation of a carry-on device in accordance with a first embodiment of present invention.

FIG. 2 is a schematic view showing the carry-on device in accordance with the first embodiment of present invention.

FIG. 3 is a block diagram showing an operation of a carry-on device in accordance with a second embodiment of present invention.

### DETAILED DESCRIPTION OF THE INVENTION

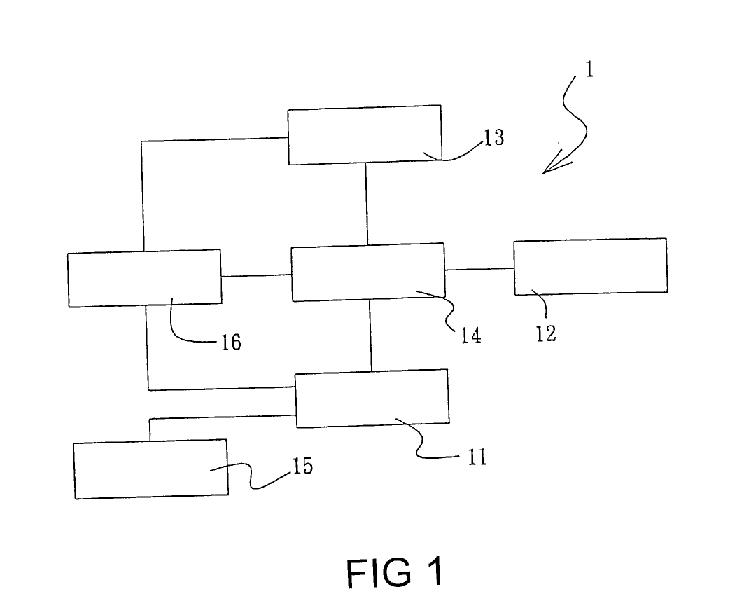

Referred to FIG. 1, a carry-on device provided in accordance with a first embodiment of present invention comprises a power supply unit 11, a storage unit 12, a cholesteric liquid crystal display 13, a control unit 14 electrically connected to the power supply unit 11, the storage unit 12 and the cholesteric liquid crystal display 13, a timing unit 15 connected to the power supply unit 11, and a power control switch 16 connected between the power supply unit 11 and the cholesteric liquid crystal display 13.

The power supply unit 11 is a battery of DC power supply source for outputting a working voltage, and the storage unit 12 is a built-in memory for a plurality of image data to be stored therein.

The cholesteric liquid crystal display 13 has two glass substrates and a cholesteric liquid crystal layer filled between said glass substrates. The cholesteric liquid crystal layer is formed of a stack of several Nematic liquid crystal layers. Molecules of each cholesteric liquid crystal layer are arranged in a spiral plane around an asymmetric carbon center. Such planes are parallel to each other, while long axes of molecules on different planes may orient in different directions so as to form an angle therebetween. The distance between two parallel planes with the long axis of molecules oriented in the same direction is defined as a “pitch”. Using electric field of different strength to change the length of the pitch, it is possible to selectively reflect light of different wavelength and then display various colors. Therefore, no back light source but the reflection of ambient nature light or artificial light source is needed to perform displaying on a cholesteric liquid crystal display with a compact-size. Since said cholesteric liquid crystal display is manufactured by an existing technology, no more details is provided in the attached drawings but simply illustrated by a box in the block diagram.

The display control unit 14 allows the cholesteric liquid crystal layer to reflect light of different wavelength by changing the strength of electric field between two glass substrates of the cholesteric liquid crystal display so as to perform displaying.

The timing unit 15 may receive a working voltage outputted from said power supply unit 11 to perform timing mode which is the ordinary timing mode of a digital watch, the detailed description will be omitted here.

User may operate the power control switch 16 to exhibit an on- or an off-state. When the power control switch is on, the display control unit 14 and the power supply unit 11 can be turned on and the cholesteric liquid crystal display 13 mat receive the work voltage from the power supply unit 11 to display the image data stored in the storage unit 12. When the user wants to constantly display a fixed image, he may turn off a power control switch 16 after selecting the image data. At this time, the power supply unit 11 supplies no electric power to the cholesteric liquid crystal display 14, and the display control unit 14 no longer changes the strength of electric field between two glass substrates of the cholesteric liquid crystal display. The cholesteric liquid crystal layer continues to reflect light of same wavelength, which means the cholesteric liquid crystal display 13 may display the image data selected before said control switch 16 was turned off. It is then possible for the cholesteric liquid crystal display 13 to perform a long time displaying of a fixed image under the condition of no electric power supplied thereto. A compact sized power saving carry-on device capable of long time image displaying is provided with functions of variety, colorful, interesting and decorative.

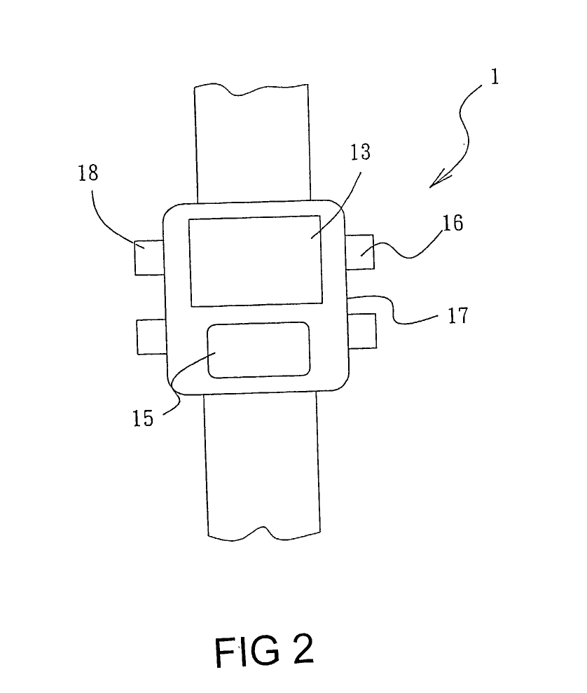

To concretely detail the carry-on device of the first embodiment having the functions of easy for carry, time and image displaying, in FIG. 2, further description is made to a product manufactured in accordance with said embodiment. However, the present invention is not limited to such product but also can be a carry-on device 1 such as a digital watch wore on the user's wrist. Said carry-on device 1 has a timing unit 15 mounted thereon, a cholesteric liquid crystal display 13 and a control switch. Elements such as power supply unit 11, storage unit 12, display control unit 14 and part of circuit in timing unit 15 as shown in FIG. 1 are provided inside the panel 17 but not explicitly shown in FIG. 2. Said timing unit 15 is used to display time. The user may push the selection key 18 to have said cholesteric liquid crystal display 13 display different image data stored in said storage unit 12 and push said control switch 16 to select a desired image when it came up. It is then possible to perform a long time constant display of the image under the condition of no electric power supplied thereto.

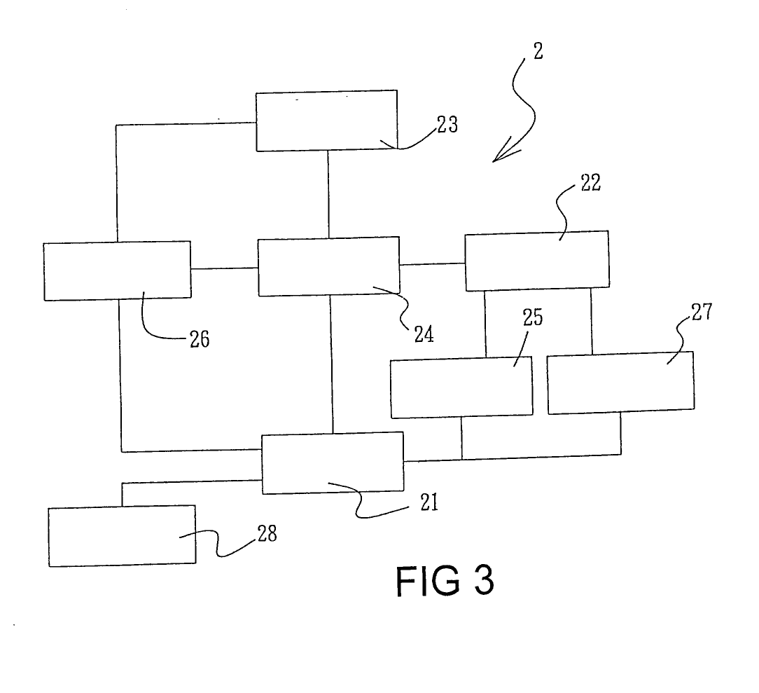

Referring to FIG. 3, a carry-on device 2 provided similar to the first embodiment of present invention comprises a power supply unit 21, a storage unit 22, a cholesteric liquid crystal display 23, a control unit 24, a timing unit 28 and a power control switch. The only difference is in that said carry-on device 2 has provided with an image capture unit 25 and a transmission interface unit 27, which are connected to the power supply unit 21 and the storage unit 22, respectively. Similar to an ordinary digital camera, the image capture unit 25 can be used to obtain light signals from an external image, and to convert said light signals into electric signals via a photoelectric conversion. Such signals are turned into image data after being processed in digitizing and encoding steps, then transmitted to and stored in the storage unit 22. The display control unit 24 is used to control the cholesteric liquid crystal display 23 and to display the image captured by the image capture unit 25. With the image capture unit 25, the carry-on device 2 can capture an image from outside and made image stored in said storage unit 23 more abundant. It is then possible for the cholesteric liquid crystal display 23 to display an image of more variety and selectivity. Further, the image data stored in the storage unit 22 can be IR-transmitted to other devices such as computer or personal digital assistant (PDA) via decoding and conversion steps performed in the transmission interface unit 27. The data conversion/transmission technology used in the transmission interface unit 27 is well known in prior art, therefore no detail description will be provided here. Also, the cholesteric liquid crystal display 23 has similar power saving function as the first embodiment, that is, the cholesteric liquid crystal display 23 may perform a long time image displaying under the condition of no electric power supplied thereto.

Summing up the above description, the present invention provides a compact sized power saving carry-on device having a cholesteric liquid crystal display, in which making use the feature of the cholesteric liquid crystal display may continuously display one image data after turning off the control switch. An image capture unit is used to capture the image according to the preference of the user so as to perform a more variety image displaying. Also, a transmission interface unit is used to perform data exchange with other devices so that it is possible to increase the usefulness and convenience and precisely achieve the object of the present invention.

Above described are preferred embodiments of present invention but not intended to be the limit of present invention, simple equivalent change and modification without departing from the claim must be considered as falling within the scope of the invention.

DESCRIPTION OF SYMBOL

| numeral | descriptions |
|---|---|
| 1, 2 | carry-on device |
| 11, 21 | power supply unit |
| 12, 22 | storage unit |
| 13, 23 | cholesteric liquid crystal display |
| 14, 24 | power control unit |
| 15, 28 | timing unit |
| 16, 26 | control switch |
| 17 | panel |
| 18 | selection key |
| 25 | image capture unit |
| 27 | transmission interface unit |

What is claimed is:

1. A carry-on device having cholesteric liquid crystal display, comprising:
a power supply unit, which is a voltage source capable of outputting a work voltage;
a storage unit, for storing a plurality of image data;
a cholesteric liquid crystal display, having two glass substrates and a cholesteric liquid crystal layer filled between said glass substrates;
a display control unit, electrically connected to the power supply unit, the storage unit and the cholesteric liquid crystal display and used to control the displaying of said cholesteric liquid crystal display according to different image data stored in said storage unit to provide continuous displaying, with said control switch in on-state, said cholesteric liquid crystal display receiving a working voltage from said power supply unit, said display control unit performing control of displaying on said cholesteric liquid crystal display to display the corresponding image of different image data, while with said control switch in off-state, said power supply unit not supplying working voltage to said cholesteric liquid crystal display, said display control unit not perform control on said cholesteric liquid crystal display, and said cholesteric liquid crystal display then displaying the image of image data before said control switch put into off-state; and
a power control switch, connected between between the power supply unit and the cholesteric liquid crystal display with an on- or off-state;
wherein with this, making use of the fact that said cholesteric liquid crystal display can display the image of image data which is displayed before said control switch was put into off-state when no power is supplied to said cholesteric liquid crystal display, it is possible to provide the function of power saving, it is then possible to perform a long time continuous display of a fixed image.

2. The carry-on device having cholesteric liquid crystal display as set forth in claim 1, further comprises a timing unit having the function of timing that is connected to said power supply unit.

3. The carry-on device having cholesteric liquid crystal display as set forth in claim 1, further comprises an image capture unit connected to said circuit unit and a storage unit, wherein said image capture unit can be used to obtain light signals from external image, and to convert said light signals into electric signals via a photoelectric conversion.

4. The carry-on device having cholesteric liquid crystal display as set forth in claim 1, further comprises a transmission interface unit connected to said storage unit for transmitting image via the connection of said transmission interface unit to other devices, wherein said other devices includes personal computers, personal digital assistant (PDA) and the like.
